(19) United States
(12) Patent Application Publication
(10) Pub. No.: US 2020/0206780 A1
(43) Pub. Date: Jul. 2, 2020

(54) ULTRASONIC SENSOR

(71) Applicant: Robert Bosch GmbH, Stuttgart (DE)

(72) Inventors: Andre Gerlach, Leonberg-Hoefingen (DE); Johannes Henneberg, Weil Im Schoenbuch (DE)

(21) Appl. No.: 16/615,937

(22) PCT Filed: May 24, 2018
(86) PCT No.: PCT/EP2018/063630

§ 371 Date: Nov. 22, 2019

(30) Foreign Application Priority Data
Jun. 9, 2017 (DE) 10 2017 209 823.6

(51) Int. Cl. B06B 1/06; G01S 7/521; G10K 9/122; G01N 29/34; G01S 15/08

(52) U.S. Cl. CPC B06B 1/0666; G01S 7/521; G01S 15/931; G01N 29/34; G01S 15/08; G10K 9/122

(57) ABSTRACT

An ultrasonic sensor includes a housing encompassing a circumferential side wall. The ultrasonic sensor includes a transducer element to convert an incoming ultrasonic signal into a detectable electrical signal, or conversely, to convert an electrical signal into an ultrasonic signal to be emitted. The ultrasonic sensor includes an oscillatable diaphragm connected to the housing. A multitude of mass elements are situated on a surface of the diaphragm. Alternatively or in addition, a multitude of mass elements are situated within the diaphragm. The mass elements form an acoustic meta material, which is a stop band material, band gap material or phononic crystal and which has a resonant behavior within a frequency band. A resonance frequency of the diaphragm including the multitude of mass elements situated on and/or within the diaphragm is within the frequency band at which the mass elements exhibit a resonant behavior.

### FIELD OF THE INVENTION

The present invention is directed to an ultrasonic sensor according to the definition of the species in main the claim.

### BACKGROUND INFORMATION

Document DE 10 2012 209 238 A1 discusses an ultrasonic sensor on whose diaphragm at least one mass element is situated in such a way that the resistance of the mass element against an oscillation of the diaphragm increases with increasing oscillation frequency. The force exerted by the at least one mass element on the diaphragm thus increases with increasing frequency. A torque exerted by the at least one mass element on the diaphragm thus may also increase with increasing frequency. As a result of the arrangement of the mass element or of the mass elements, the effect is achieved that the resistance of the mass element or of the mass elements against the oscillation of the diaphragm is low at low oscillation frequencies, but increases at higher frequencies.

### SUMMARY OF THE INVENTION

It is an object of the present invention to develop an ultrasonic sensor having improved properties for the acoustic emission at different working frequencies.

An ultrasonic sensor according to the features as described herein is provided to achieve the object, according to the present invention.

According to the present invention, the ultrasonic sensor includes a housing encompassing a circumferential side wall. The electronic components of the ultrasonic sensor are known to be situated in the housing, among other things. Additionally, the ultrasonic sensor includes a transducer element, which is configured to convert an incoming ultrasonic signal into a detectable electrical signal, or conversely, to convert an electrical signal into an ultrasonic signal to be emitted. In order to achieve a large electromechanical conversion effect, the known ultrasonic sensors are resonantly operated. In addition to the piezoelectric transducer principle, e.g., electrostatic transducers, electret transducers or piezoelectret transducers are known. In addition, the ultrasonic sensor includes an oscillatory diaphragm connected to the housing. The diaphragm may, for example, be clamped as an individual part into the housing; however, it may also be an integral part of a diaphragm cup. According to the present invention, a multitude of mass elements are situated on a surface of the diaphragm. As an alternative or in addition, a multitude of mass elements are situated within the diaphragm.

These mass elements form an acoustic meta material, which is also known as stop band material, band gap material or phononic crystal. If a plurality of mass elements having identical or very similar mechanical oscillations in terms of properties are now situated on a surface and/or within the diaphragm, it is possible to mitigate the free wave propagation in a particular frequency band. The mass elements then function as oscillation dampers since, within this frequency band, they deprive the diaphragm of oscillation energy for their own oscillating movements and behave resonantly. This property may be used to influence the oscillation mode of the diaphragm by matching the described frequency band of the mass elements having resonant behavior to a resonance frequency for flexural oscillations of the overall system, made up of the diaphragm and the multitude of mass elements situated on and/or within the diaphragm, in such a way that the resonance frequency of the overall system is within the frequency band having resonant behavior of the mass elements.

In principle, it is possible to operate an ultrasonic sensor at different frequencies which correspond to its resonance frequencies of the diaphragm flexural oscillations. The diaphragm oscillates geometrically differently at different frequencies. In this way, different oscillation modes result, not all of which, however, are equally suitable for the operation of an ultrasonic sensor in a vehicle, in particular for distance measurement, since due to the different oscillation modes, for example, different directional characteristics (emission characteristics), and thus different sound pressures of the emitted sound waves result. Excessively high frequencies, for example, of greater than 100 kHz are less suitable for a distance measurement in a vehicle since sound waves in this frequency range are very strongly attenuated by air. As a result of the arrangement according to the present invention, it is advantageously possible to change the oscillation modes of the diaphragm having a nodal circle or a nodal ellipse in such a way that improved properties result with respect to sound emission. Another advantage is that the oscillation modes of different resonance frequencies may be influenced independently of one another since the acoustic meta material only mitigates or prevents a free wave propagation in a particular frequency band.

The mass elements may be embedded into the diaphragm. This has the advantage that no additional space is required for mass elements on a surface of the diaphragm. The mass elements also do not have to be additionally attached to the diaphragm. The mass elements may represent ball resonators. These may, for example, be implemented as silicone-coated steel balls in an epoxy resin matrix. The frequency band of the mass elements may be set relatively easily in the process via the mass-stiffness ratio of the ball resonators. Since the ball resonators do not require any space in the interior of the housing, it may be provided that the transducer element is implemented as an electrostatic transducer element. For this purpose, a first electrode of the electrostatic transducer element is situated on an inner side of the diaphragm, and a second electrode is situated on a carrier element. The carrier element is situated in the interior of the housing.

In an alternative embodiment, the mass elements are connected to an outer surface of the diaphragm. This is, in particular, the inner side of the diaphragm oriented toward the interior of the housing. One advantage is that the mass elements may be implemented relatively easily as bending beams or as longitudinal oscillators. Rod resonators are relatively easy to manufacture, and their properties may be adjusted easily by the length and diameter. Bending beams are rod resonators.

The transducer element may represent a piezoelectric element which is connected to an inner side of the diaphragm. The piezoelectric element serves the electromechanical conversion. In the sending mode, the diaphragm is made to oscillate by the piezoelectric element after the application of a voltage, and in the receive mode, the piezoelectric element converts a deformation of the diaphragm into an electrical signal.

The resonance frequency, which is within the frequency band of the mass element, may be a frequency of the diaphragm including the multitude of mass elements situated on and/or within the diaphragm at which an oscillation mode having a nodal circle or a nodal ellipse of the diaphragm including the multitude of mass elements situated on and/or within the diaphragm forms. This oscillation mode is advantageous compared to a second oscillation mode, for example, since it does not have a nodal line in the center. A nodal line is disadvantageous since different areas of the diaphragm oscillate in different directions and thus form different sound pressures, as a result it is not possible to send or receive ultrasonic signals in a directional manner. Whereas one half of the diaphragm oscillates in the positive direction, the other half oscillates in the negative direction. If the mass elements are now situated in the outer area of the diaphragm, a deflection is mitigated, or even prevented, at this resonance frequency with an oscillation mode having a nodal circle in the outer area. In this way, the oscillation mode is influenced to the effect that the center of the diaphragm is strongly deflected, but the boundary areas, outside the area enclosed by the nodal circle, are little deflected or are not deflected at all. Ultrasonic signals may thus be received in a directional manner, and also be sent in a directional manner. Another first working frequency of the ultrasonic sensor which may be used is a resonance frequency of the diaphragm including the multitude of mass elements situated on and/or within the diaphragm at which an oscillation mode having no nodal circles and having no nodal lines of the diaphragm including the multitude of mass elements situated on and/or within the diaphragm forms as the overall system. This results in the advantage of being able to operate the ultrasonic sensor at two different working frequencies.

The ultrasonic sensor may be configured as a distance sensor. It may be used in a driver assistance system of a motor vehicle. Such distance sensors are used, for example, for distance measurement between vehicles and obstacles, such as to support a parking process.

### BRIEF DESCRIPTION OF THE DRAWINGS

FIG. 1a shows a first specific embodiment of the ultrasonic sensor during the excitation of the diaphragm with the aid of a resonance frequency including an oscillation mode without nodal circles and nodal lines.

FIG. 1b shows the first specific embodiment of the ultrasonic sensor during the excitation of the diaphragm with the aid of a resonance frequency including an oscillation mode encompassing a nodal circle/ellipse.

FIG. 2a shows a second specific embodiment of the ultrasonic transducer.

FIG. 2b shows a third specific embodiment of the ultrasonic transducer.

FIG. 3a shows a first option of the arrangement of rod resonators on the diaphragm.

FIG. 3b shows a second option of the arrangement of rod resonators on the diaphragm.

FIG. 3c shows a first option of the arrangement of ball resonators on the diaphragm; and

FIG. 3d shows a second option of the arrangement of ball resonators on the diaphragm.

### DETAILED DESCRIPTION

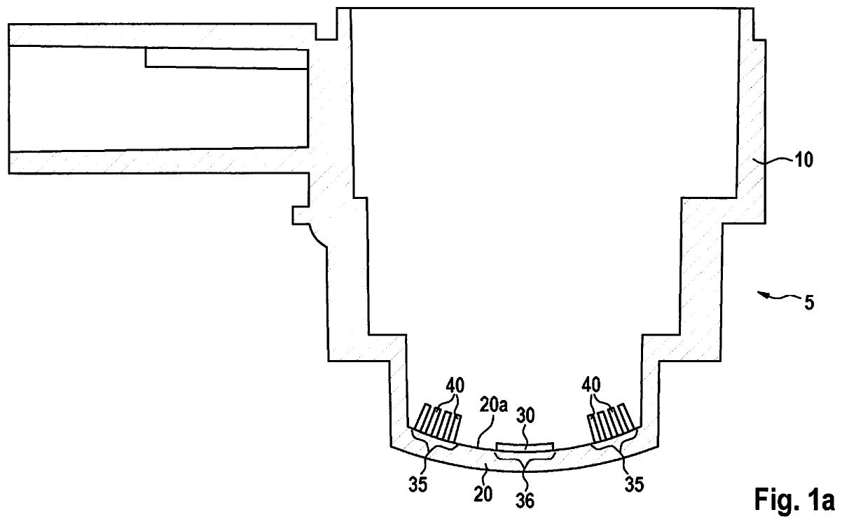

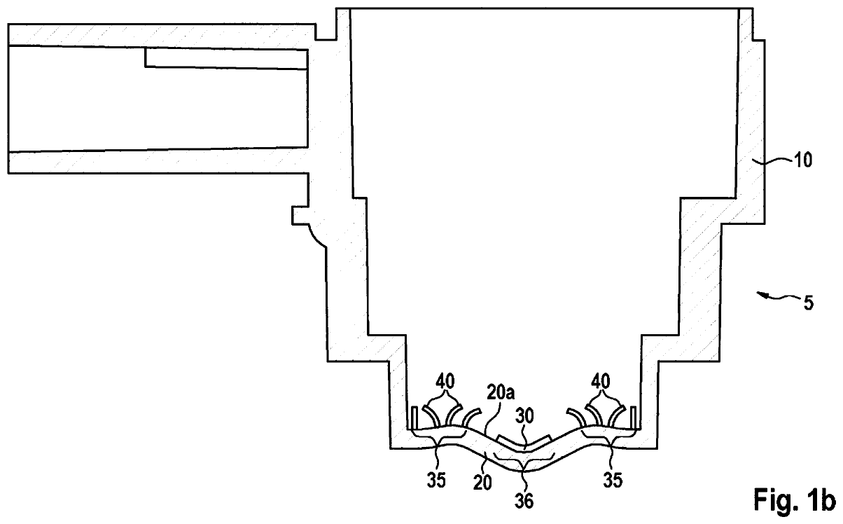

The first specific embodiment of the ultrasonic sensor in FIG. 1a shows housing 5 of the ultrasonic sensor, which includes a circumferential side wall 10. The bottom of housing 5 is formed with the aid of diaphragm 20, which is configured in such a way that it is excitable to carry out oscillations. On inner side 20a of diaphragm 20, a piezoelectric element 30 is situated in its center 36, and a multitude of rod resonators are situated on outer diaphragm area 35 as mass elements 40. In the situation shown in FIG. 1a, the overall system, made up of housing 5 including diaphragm 20 and the multitude of mass elements 40 situated on the inner side of diaphragm 20, is excited with the aid of a first resonance frequency to carry out an oscillation having an oscillation mode having no nodal circles and having no nodal lines on diaphragm 20. The rod resonators situated on outer diaphragm area 35 as mass elements 40 do not show any resonant behavior at this operating point.

In contrast to FIG. 1a, FIG. 1b shows a situation in which the overall system, made up of diaphragm 20 and the rod resonators situated on inner side 20a as mass elements 40, is excited with the aid of a resonance frequency to carry out an oscillation having an oscillation mode having a nodal circle/ellipse on the diaphragm. Mass elements 40 are configured in such a way that, in this case, the resonance frequency of diaphragm 20 and the frequency band in which mass elements 40 situated on diaphragm 20 show a resonant behavior coincide. In this case, mass elements 40 thus also resonantly co-oscillate during the oscillation of diaphragm 20 and deprive diaphragm 20 of oscillation energy for their own oscillating movements. In this way, a free wave propagation and a deflection of diaphragm 20 are prevented on outer diaphragm area 35. In this way, an oscillation mode which has no nodal lines and a nodal circle is achieved. This results in an oscillation mode which has a deflection at the diaphragm center, but little or no deflection in the boundary areas, outside the area enclosed by the nodal circle. In the area of the diaphragm deflection, the oscillation mode is thus adapted, taking a different oscillation amplitude of the oscillation mode from FIG. 1a into consideration, to the effect that only one antinode results, or 3 antinodes, of which the 2 outer ones have only a very small deflection.

Both FIG. 1a and FIG. 1b do not show a representation true to scale, but the deflection of diaphragm 20 is shown highly exaggerated.

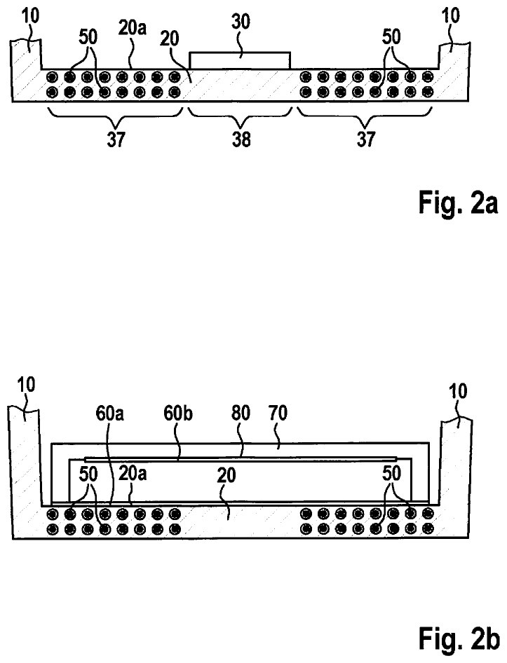

FIG. 2a shows a second specific embodiment of the ultrasonic sensor including a portion of circumferential side wall 10 of the housing. Ball resonators may be embedded into diaphragm 20 as mass elements 50 in the process. The ball resonators may, for example, include silicone-coated steel balls in an epoxy resin matrix. The lead balls within the matrix also co-oscillate as a function of an excitation of the overall system, made up of diaphragm 20 and ball resonators, with the aid of a resonance frequency which is within the frequency band of the resonant behavior of the sphere resonators. In this way, diaphragm 20 is deprived of oscillation energy for its own oscillating movements, and a deflection of diaphragm 20 into outer diaphragm areas 37 in which the ball resonators are embedded is at least mitigated or even entirely prevented. In this second exemplary embodiment, transducer element 30 is configured as a piezoelectric element, which is connected in center 38 of the diaphragm to inner side 20a of diaphragm 20.

In a third specific embodiment of the ultrasonic sensor in FIG. 2b, the ultrasonic sensor, in contrast to FIG. 2a, includes a transducer element 60a and 60b, which is implemented as an electrostatic transducer. A first electrode 20a is situated on inner side 20a of diaphragm 20, and a second electrode 60b is situated on a side 80 of carrier element 70 situated opposite inner side 20a of diaphragm 20.

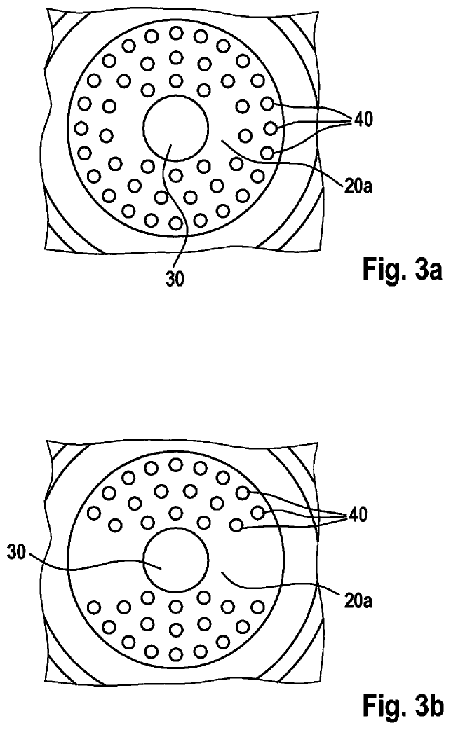

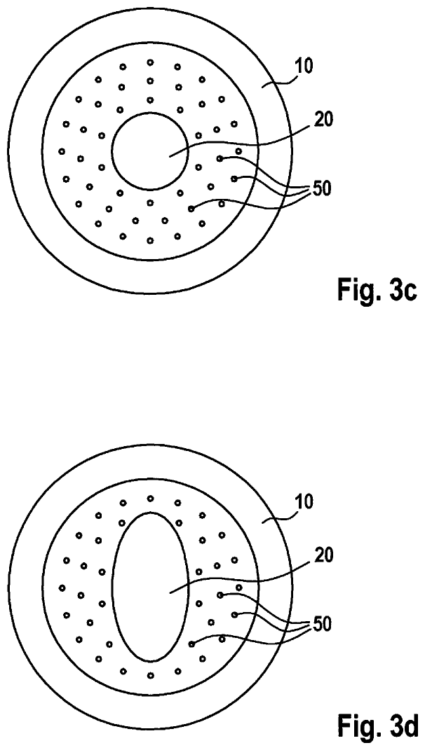

FIG. 3a, in the top view, shows a first possible arrangement of rod resonators as mass elements 40 on inner side 20a of the diaphragm. The rod resonators are situated in the outer area of the diaphragm in such a way that the wave propagation is mitigated both perpendicular to and in parallel to the diaphragm main axis.

A piezoelectric element 30 is situated centrically on inner side 20a of the diaphragm.

FIG. 3b, in the top view, shows a second possible arrangement of rod resonators as mass elements 40 on inner side 20a of the diaphragm. The rod resonators are situated in the outer area of the diaphragm in such a way that the wave propagation is mitigated more strongly perpendicular to the diaphragm main axis, and thus the formation of an oscillation mode having a nodal ellipse is supported. Piezoelectric element 30 is also situated centrically on inner side 20a of the diaphragm.

FIG. 3c, in the top view, shows a first possible arrangement of ball resonators as mass elements 50 within diaphragm 20. The ball resonators are situated in the outer area of the diaphragm in such a way that an elliptical area free of mass elements results in the center of the diaphragm. In this way, the wave propagation is mitigated more strongly perpendicular to the diaphragm main axis, and thus the formation of an oscillation mode having a nodal ellipse is supported.

FIG. 3d, in the top view, shows a second possible arrangement of ball resonators as mass elements 50 within diaphragm 20. The ball resonators are situated in the outer area of the diaphragm in such a way that a circular area free of mass elements results in the center of the diaphragm. In this way, the wave propagation is mitigated both perpendicularly to and in parallel to the diaphragm main axis.

1-9. (canceled)

10. An ultrasonic sensor, comprising:
a housing including a circumferential side wall;
a transducer element to generate or to detect ultrasonic oscillations;
a diaphragm connected to the housing; and
a multitude of mass elements situated on a surface of the diaphragm and/or within the diaphragm;
wherein the mass elements form an acoustic meta material including a frequency band, wherein the mass elements have a resonant behavior within the frequency band, and wherein a resonance frequency of the diaphragm includes the multitude of mass elements situated on and/or within the diaphragm is within the frequency band of the mass elements.

11. The ultrasonic sensor of claim 10, wherein the mass elements are embedded into the diaphragm.

12. The ultrasonic sensor of claim 10, wherein the mass elements are connected to an outer surface of the diaphragm.

13. The ultrasonic sensor of claim 11, wherein the mass elements represent ball resonators.

14. The ultrasonic sensor of claim 12, wherein the mass elements represent rod resonators.

15. The ultrasonic sensor of claim 10, wherein the transducer element represents an electrostatic transducer element, a first electrode of the electrostatic transducer element being situated on an inner side of the diaphragm, and a second electrode of the electrostatic transducer element being situated on a carrier element.

16. The ultrasonic sensor of claim 10, wherein the transducer element represents a piezoelectric element and is connected to an inner side of the diaphragm.

17. The ultrasonic sensor of claim 10, wherein the resonance frequency of the diaphragm includes the multitude of mass elements situated on and/or within the diaphragm corresponds to a frequency at which an oscillation mode having a nodal circle or a nodal ellipse of the diaphragm including the multitude of mass elements situated on and/or within the diaphragm forms.

18. The ultrasonic sensor of claim 10, wherein the ultrasonic sensor is a distance sensor.

19. The ultrasonic sensor of claim 10, wherein the ultrasonic sensor is a distance sensor for use in a driver assistance system of a motor vehicle.
